(19) United States
(12) Patent Application Publication
(10) Pub. No.: US 2024/0082950 A1
(43) Pub. Date: Mar. 14, 2024

(54) LASER PROCESSING DEVICE AND AUTOMATIC CORRECTION METHOD FOR FOCAL POINT POSITION OF LASER LIGHT

(71) Applicant: Panasonic Intellectual Property Management Co., Ltd., Osaka (JP)

(72) Inventors: JIN MATSUZAKA, Osaka (JP); SHUNSUKE KAWAI, Osaka (JP); JINGBO WANG, Hyogo (JP); KENZO SHIBATA, Hyogo (JP)

(21) Appl. No.: 18/513,665

(22) Filed: Nov. 20, 2023

Related U.S. Application Data
(63) Continuation of application No. PCT/JP2022/024468, filed on Jun. 20, 2022.

(30) Foreign Application Priority Data
Jun. 29, 2021 (JP) 2021-107933
Jun. 29, 2021 (JP) 2021-107934

(51) Int. Cl. B23K 26/064; B23K 26/03

(52) U.S. Cl. CPC B23K 26/064; B23K 26/032

(57) ABSTRACT

The laser processing device includes a laser head that emits laser light and a camera that acquires a surface image of a processing member after being irradiated with the laser light. The laser processing device further includes an image processor that performs image processing on an acquired surface image and calculates a diameter of a processing mark, and an autofocus controller that derives an optimum focal position of the laser light based on the diameter of the processing mark. In addition, the laser processing device includes a driver that moves the laser head in an emission direction of the laser light to allow the laser light to be condensed at an optimum focal position based on the derivation result of the autofocus controller.

### TECHNICAL FIELD

The present disclosure relates to a laser processing device, and to a method for automatically correcting a focal position of laser light.

### BACKGROUND ART

Conventionally, methods have been known for adjusting a posture of a laser processing device and a focal position of laser light based on a state and a shape of a processed member (see Patent Literatures 1 to 5).

### CITATION LIST

### Patent Literature

PTL 1: Japanese Patent No. 3385362 B2
PTL 2: Japanese Patent No. 4583955 B2
PTL 3: Japanese Patent No. 2677856 B2
PTL 4: Unexamined Japanese Patent Publication No. H10-258382 A
PTL 5: Unexamined Japanese Patent Publication No. H07-051875 A

### SUMMARY OF THE INVENTION

### Technical Problem

Incidentally, when machining quality deteriorates during laser processing, a focal position of laser light deviates from a set position in some cases. Such a problem occurs after, for example, a laser head of a laser processing device is replaced.

A method for measuring a beam diameter of laser light on a surface of a processing member when a shift in a focal position of the laser light occurs and correcting the positional shift based on the result is well known.

However, in this case, a dedicated device such as a focus monitor and a dedicated jig are required, and a maintenance worker having a skill to operate the dedicated device is required. In addition, it is necessary to continue the laser processing in a state where processing quality is deteriorated or to interrupt the processing until an adjustment work of the laser processing device by a maintenance worker is completed, and in either case, productivity is deteriorated.

The present disclosure has been made in view of such a point, and an object of the present disclosure is to provide a laser processing device capable of correcting a focal position of laser light without requiring a dedicated device or a maintenance worker, and a method for automatically correcting a focal position of laser light.

### Solution to Problem

In order to achieve the above object, a laser processing device according to the present disclosure includes: a laser head that emits laser light; a camera that acquires surface image of a processing member that has been irradiated with the laser light; an image processor that calculates a diameter of a processing mark by performing image processing on the acquired surface image; an autofocus controller that derives an optimum focal position of the laser light based on the diameter of the processing mark; and a driver that moves the laser head or an optical component inside the laser head in an emission direction of the laser light based on a derivation result of the autofocus controller to allow the laser light to be condensed at the optimum focal position.

A method for automatically correcting a focal position of laser light according to the present disclosure is an automatic correction method of a focal position of laser light emitted from a laser head, the method including: a first step of spot-irradiating a processing member with the laser light; a second step of acquiring a surface image of the processing member after irradiation with the laser light; a third step of measuring a diameter of a processing mark formed on a surface of the processing member based on the surface image of the processing member acquired in the second step; a fourth step of deriving an optimum focal position of the laser light based on the diameter of the processing mark; and a fifth step of moving the laser head or an optical component inside the laser head in an emission direction of the laser light to allow the laser light to be condensed at the optimum focal position.

### Advantageous Effect of Invention

According to the present disclosure, it is possible to automatically correct a focal position of laser light without requiring a dedicated device or a maintenance worker.

### BRIEF DESCRIPTION OF THE DRAWINGS

FIG. 1 is a schematic configuration diagram of a laser processing device according to a first exemplary embodiment.

FIG. 2 is a flowchart illustrating a procedure for automatically correcting a focal position of laser light.

FIG. 3 is a schematic diagram illustrating a relationship between a beam diameter and a focal position of laser light.

FIG. 4A is a photograph showing an example of a processing mark and a heat-affected zone formed on a surface of a processing member.

FIG. 4B is a schematic cross-sectional view of a processing mark and a heat-affected zone.

FIG. 5 is a schematic diagram illustrating a state of a change in size of a processing mark and a heat-affected zone when a height of a laser head is changed.

FIG. 6 is an example illustrating a relationship between a distance from a tip of a laser head to a processing member and diameters of a processing mark and a heat-affected zone.

FIG. 7 is a schematic configuration diagram of a laser processing device according to a second exemplary embodiment.

FIG. 8 is a flowchart illustrating a procedure for automatically adjusting a focal position of laser light.

FIG. 9 is a photograph showing an example of a processing mark and a heat-affected zone formed on a surface of a processing member.

FIG. 10 is a schematic diagram illustrating a relationship between a beam diameter and a focal position of laser light.

FIG. 11A is a schematic diagram illustrating a relationship between a distance from a center of laser light and a light intensity.

FIG. 11B is a schematic diagram illustrating a relationship between a distance from a center of laser light and a member temperature.

FIG. 12 is a schematic diagram illustrating a state of a change in size of a processing mark and a heat-affected zone when a height of a laser head is changed.

FIG. 13 is an example illustrating a relationship between a distance from a tip of a laser head to a processing member and diameters of a processing mark and a heat-affected zone.

### DESCRIPTION OF EMBODIMENT

Hereinafter, exemplary embodiments of the present disclosure will be described with reference to the drawings. Note that the following description of preferred exemplary embodiments is merely exemplary in nature, and is not intended to limit the present disclosure, its application, or its use.

### First Exemplary Embodiment

[Configuration of Laser Processing Device]

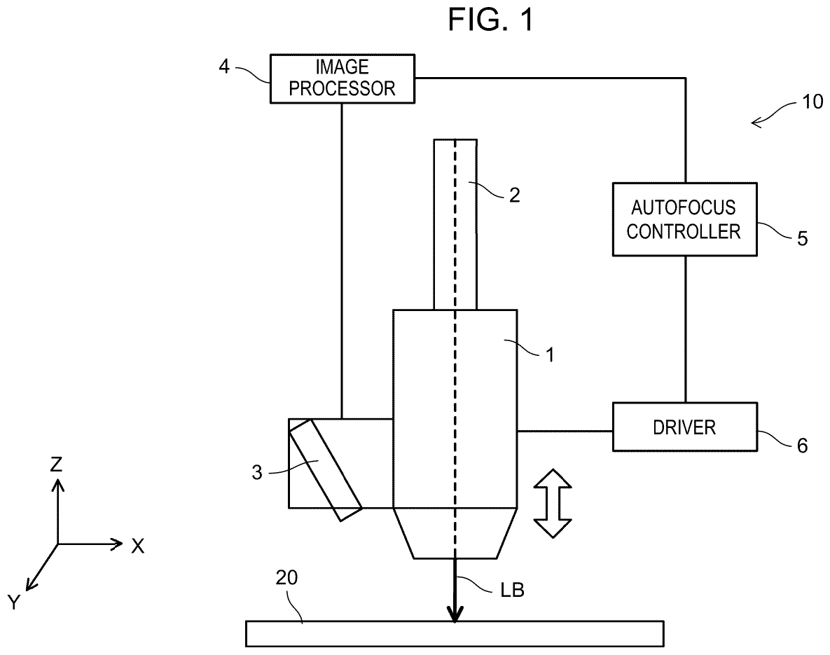

FIG. 1 illustrates a schematic configuration diagram of a laser processing device according to a first present exemplary embodiment, and laser processing device 10 includes a laser head 1, a camera 3, an image processor 4, an autofocus controller 5, and a driver 6. Furthermore, laser processing device 10 includes an optical fiber 2.

Note that laser processing device 10 includes a laser oscillator generating laser light LB, a laser controller controlling the laser oscillator, and the like, but for convenience of description, components other than ones illustrated in FIG. 1 are not illustrated and detailed description is omitted.

Furthermore, in the following description, an optical axis direction of laser light LB emitted from laser head 1 (hereinafter may be simply referred to as an emission direction of laser light LB) may be referred to as a Z direction. Furthermore, two directions located in a plane intersecting with the Z direction that intersect with each other may be referred to as an X direction and a Y direction. In an example illustrated in FIG. 1, a surface of processing member 20 having a flat shape corresponds to a plane including the X direction and the Y direction.

Laser head 1 receives laser light LB from optical fiber 2 and emits light toward processing member 20. Laser head 1 internally includes a plurality of optical components, for example, a collimator lens and a condenser lens (both not illustrated). In addition, a protective glass (not illustrated) is provided to cover an opening (not illustrated) provided at the tip of laser head 1. However, not only they but also other optical components such as a reflection mirror may be disposed inside laser head 1.

When laser light LB enters laser head 1 from optical fiber 2, laser light LB is converted into a parallel light by a collimator lens (not illustrated). Laser light LB is further condensed at a predetermined focal position by a condenser lens (not illustrated).

Optical fiber 2 is an optical member that transmits laser light LB generated by a laser oscillator (not illustrated) to laser head 1. Camera 3 is attached to laser head 1 and captures a surface image of processing member 20 after processing member 20 is irradiated with laser light LB. Camera 3 is provided with an imaging element (not illustrated) such as a CMOS image sensor. Furthermore, an illumination light source (not illustrated) for capturing a surface image of processing member 20 may be provided. Furthermore, a mirror (not illustrated) allowing light reflected by the surface of processing member 20 to enter camera 3 may be provided inside laser head 1.

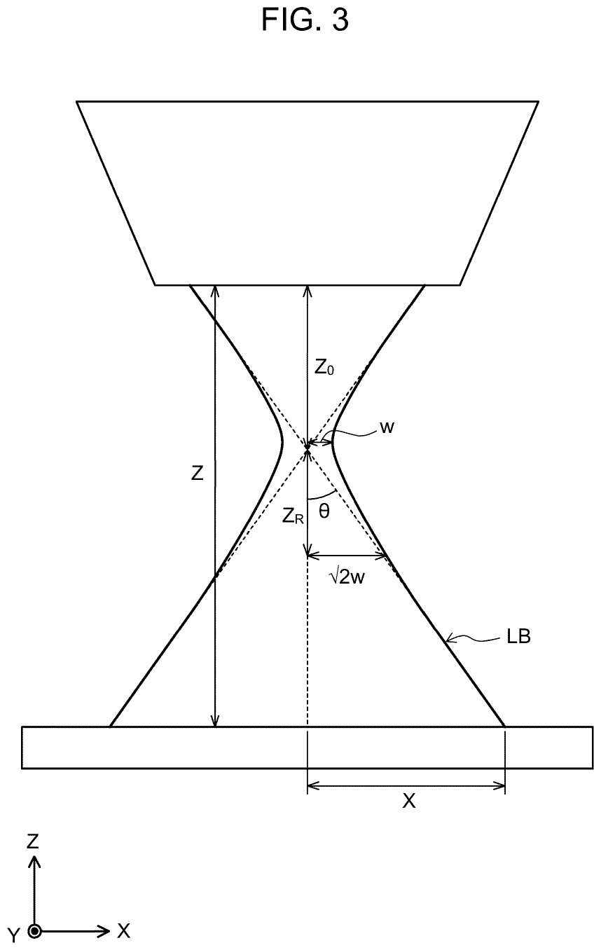

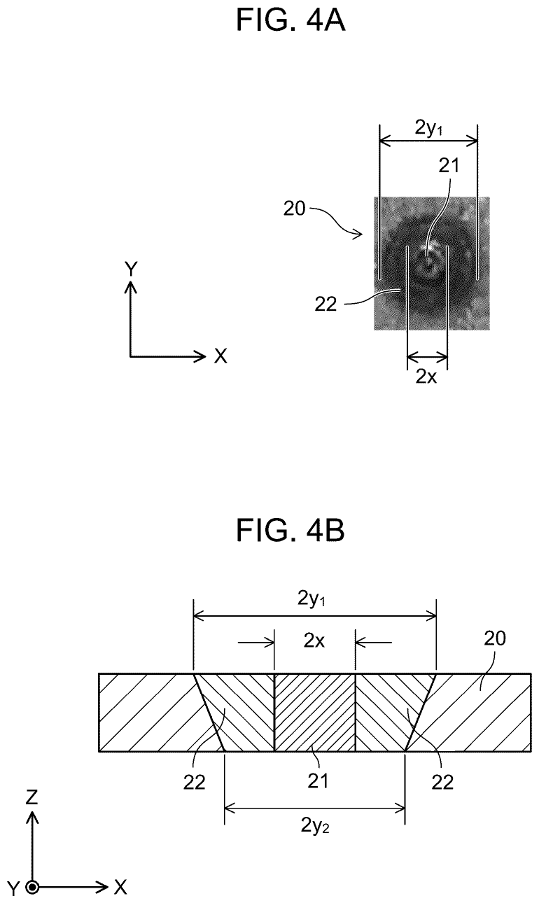

Image processor 4 performs image processing on the surface image of processing member 20 acquired by camera 3 to identify processing mark 21 (see FIGS. 4A and 4B) and heat-affected zone 22 (see FIGS. 4A and 4B) formed around processing mark 21. In addition, image processor 4 calculates a diameter 2x (see FIG. 3) of processing mark 21.

Note that processing mark 21 is a mark obtained by cooling and solidifying a molten portion formed when the surface of processing member 20 is irradiated with laser light LB. In addition, when the molten portion is formed, the temperature is greatly increased around the molten portion although the molten portion is not melted. Therefore, properties of processing member 20, for example, a structure or a composition changes in some cases. Alternatively, the surface unevenness of processing member 20 greatly changes in some cases. When processing mark 21 is formed in this manner, a portion where the property, surface unevenness, or the like formed around processing mark 21 are changed due to a temperature rise is referred to as heat-affected zone 22 in the present description. They will be further described later.

Autofocus controller 5 derives an optimum focal position of laser light LB based on a correction program to be described later and a diameter (see FIG. 3 and FIGS. 4A and 4B) of processing mark 21 calculated by image processor 4. A procedure for deriving the optimum focal position will be described later.

Image processor 4 includes, for example, a known graphic processing unit (GPU).

Autofocus controller 5 includes, for example, a known central processing unit (CPU). Image processor 4 and autofocus controller 5 may be each configured as a functional block inside one GPU or CPU. Note that, in a case where autofocus controller 5 includes a memory (not illustrated), the above-described correction program may be stored in the memory. The correction program is called from the memory to perform automatic correction of a focal position. Note that the correction program may be stored in another memory (not illustrated). In that case, another memory may be provided outside laser processing device 10. It is only necessary that data can be exchanged with autofocus controller 5.

Driver 6 moves laser head 1 in the Z direction that is an emission direction of laser light LB to allow laser light LB to be condensed at the optimum focal position based on the derivation result of autofocus controller 5. Driver 6 includes, for example, a ball screw (not illustrated) extending in the Z direction and a stepping motor (not illustrated 9 connected to the ball screw. In addition, the ball screw is connected to laser head 1. Based on the information of the optimum focal position received from autofocus controller 5, the stepping motor is driven, the ball screw is rotated, and laser head 1 is moved to a desired position in the Z direction.

[Method for Automatically Correcting Focal Position of Laser Light]

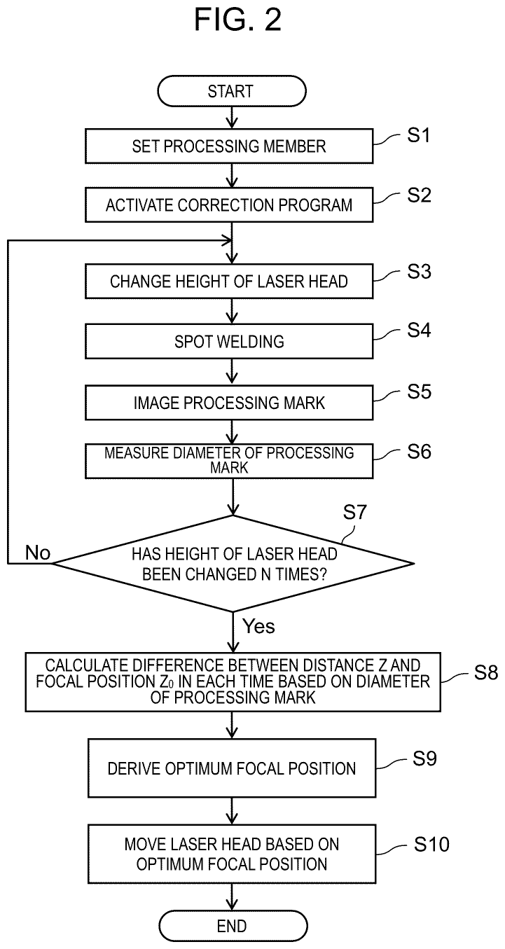

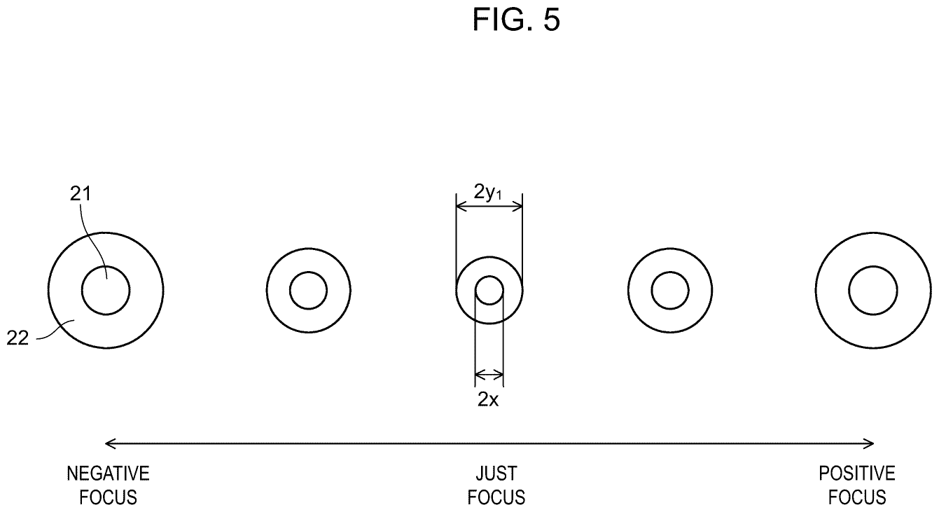

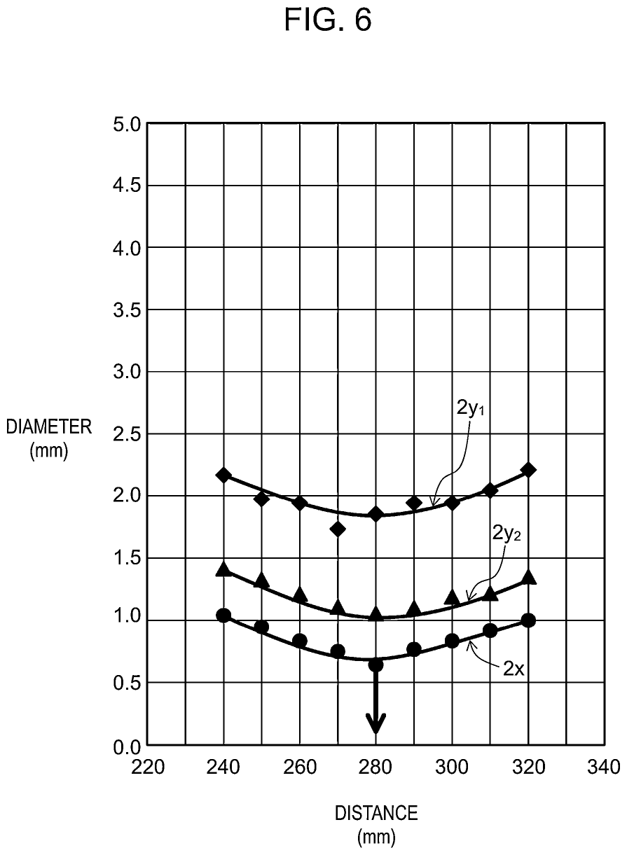

FIG. 2 is a flowchart of a procedure for automatically correcting a focal position of laser light, and FIG. 3 schematically illustrates a relationship between the beam diameter of the laser light and the focal position. FIG. 4A illustrates an example of a processing mark and a heat-affected zone formed on a surface of a processing member, and FIG. 4B illustrates a schematic cross-sectional view of the processing mark and the heat-affected zone. FIG. 5 is a schematic diagram illustrating a state of a change in size of a processing mark and a heat-affected zone when a height of a laser head is changed. FIG. 6 is an example illustrating a relationship between a distance from a tip of a laser head to a processing member and diameters of a processing mark and a heat-affected zone.

In automatically correcting a focal position of laser light LB, as illustrated in FIG. 2, first, processing member 20 is set at a predetermined position (step S1), and a correction program is activated (step S2).

Next, a height of laser head 1 in the Z direction is changed (step S3), and processing member 20 is spot-welded by spot irradiation with laser light LB (step S4). Furthermore, processing mark 21 and heat-affected zone 22 formed by spot welding are imaged by camera 3 (step S5), and diameter 2x of processing mark 21 is measured based on an acquired image (step S6).

A height of laser head 1 in the Z direction is changed again. In addition, it is determined whether or not a height of laser head 1 in the Z direction has been changed a fixed number of times (=N times) (step S7). When the determination result in step S7 is negative, the process returns to step 3, and a series of processes from step S4 to step S6 is repeatedly executed. Note that step S7 may be determined inside laser processing device 10. For example, the number of times of operation start of driver 6 may be counted by a controller (not illustrated). Alternatively, step S7 may be determined by a worker on site.

Here, N is an integer greater than or equal to two. N is preferably a minimum value required to derive an optimum focal position. This is because the preprocessing for correcting a focal position is simplified, and the downtime of laser processing device 10 can be shortened.

When the determination result in step S7 is positive, a difference between distance z and focal position z₀ obtained in each of the N trials is calculated based on diameter 2x of processing mark 21 measured in step S6 (step S8). An optimum focal position is derived based on the calculation result in step S8 (step S9). Laser head 1 is moved in the Z direction to allow laser light LB to be condensed at the optimum focal position (step S10), and the automatic correction is completed. The automatic correction procedure described above will be further described.

As illustrated in FIG. 3, a beam diameter of laser light LB emitted from laser head 1 is the smallest at the beam waist. When laser light LB further travels from this position, laser light LB spreads with a predetermined beam divergence angle, and the beam diameter increases.

A wavelength of laser light LB is defined as λ. A beam diameter of laser light LB on a surface of processing member 20 is defined as 2x, and a focal position of laser light LB with respect to a tip of laser head 1 is defined as z₀. A distance from the tip of laser head 1 to the surface of processing member 20 is defined as z, and a beam diameter of laser light LB at the beam waist is defined as 2w. A Rayleigh length of laser light LB is defined as z_{R}, and a beam divergence angle of laser light LB is defined as θ. When each parameter is defined in this way, a known beam propagation equation satisfies a relationship shown in Mathematical formula (1).

$$\begin{matrix}[ Mathematical formula 1 ] & \\ x = w \sqrt{1 + {( \frac{λ ( z - {z}_{0} )}{π {w}^{2}} )}^{2}} = w \sqrt{1 + {( \frac{z - {z}_{0}}{{z}_{R}} )}^{2}} = ( z - {z}_{0} ) tan θ & ( 1 )\end{matrix}$$

In addition, it can be seen that, when Mathematical formula (1) is transformed, focal position z₀ satisfies a relationship shown in Mathematical formula (2).

$$\begin{matrix}[ Mathematical formula 2 ] & \\ {z}_{0} = z - {z}_{R} \sqrt{{( \frac{x}{w} )}^{2} - 1} = z - \frac{x}{tan θ} & ( 2 )\end{matrix}$$

As described above, a beam diameter of laser light LB is the smallest at the beam waist. Therefore, if a surface of processing member 20 is disposed at this position, processing member 20 can be subjected to laser processing with the beam being most focused. That is, the position corresponds to the optimum focal position. Furthermore, as is clear from FIG. 3 and Mathematical formula (2), a difference between distance z and focal position z₀ is obtained, and the tip of laser head 1 is moved to distance z at which the difference is minimized. With this adjustment, laser light LB emitted from laser head 1 is condensed at the optimum focal position. Note that, as is clear from FIG. 3, a theoretical minimum value of the difference between distance z and focal position z₀ obtained by Mathematical formula (2), which is an approximate Mathematical formula, is w/tan θ. Since w is generally small enough, Mathematical formula (2) is adequate as a focal position adjustment Mathematical formula.

On the other hand, as described above, when a beam diameter of laser light LB is directly measured, a dedicated device such as a focus monitor is required. In addition, a maintenance worker who can operate the dedicated device is required.

Therefore, inventors of the present application have focused on processing mark 21 formed by spot welding instead of directly measuring the beam diameter. A size of processing mark 21 corresponds to a beam diameter of laser light LB on a surface of processing member 20. By setting the diameter of processing mark 21 to 2x in Mathematical formulas (1) and (2), an optimum focal position can be derived with the above-described procedure.

On the other hand, as illustrated in FIG. 4A, when processing member 20 is spot-welded, a circular portion formed at the center and an annular portion different in state from a surface of processing member 20 are formed around the circular portion. The former is processing mark 21, and the latter is heat-affected zone 22 described above. As illustrated in FIG. 4B, in heat-affected zone 22, diameter 2y₁ on an irradiation surface of laser light LB is larger than diameter 2y₂ on a surface opposite to the irradiation surface due to an influence of heat propagation.

As illustrated in FIG. 5, both diameter 2x of processing mark 21 and diameter 2y₁ of heat-affected zone 22 change depending on a focus state of laser light LB. In a case where a height of laser head 1 is not appropriately set, in an example illustrated in FIG. 5, when laser light LB swings to a positive focus, diameter 2x of processing mark 21 and diameter 2y₁ of heat-affected zone 22 both increase. Similarly, when laser light LB swings to a negative focus, diameter 2x of processing mark 21 and diameter 2y₁ of heat-affected zone 22 both increase. When laser light LB is in a just focus state, that is, laser light LB is at an optimum focal position, both diameter 2x of processing mark 21 and diameter 2y₁ of heat-affected zone 22 are minimum.

FIG. 6 illustrates, as an example, changes in diameter 2x of processing mark 21 and diameter 2y₁ of heat-affected zone 22 with respect to distance z. Note that, for reference, a change in a diameter 2y₂ of heat-affected zone 22 is also illustrated. In an example illustrated in FIG. 6, a diameter 2x of processing mark 21 and a diameter 2y₁ of heat-affected zone 22 similarly tend to change with respect to a distance z, and both have a minimum value at a distance z of 280 mm.

In this example, it seems that an optimum focal position can be derived using either diameter 2x of processing mark 21 or diameter 2y₁ of heat-affected zone 22. However, diameter 2y₁ of heat-affected zone 22 is affected more greatly than diameter 2x of processing mark 21 by variations in a material of processing member 20. In addition, since the contrast of a peripheral edge of heat-affected zone 22 is less clear than the contrast of a peripheral edge of processing mark 21, a measurement accuracy of diameter 2y₁ may decrease.

Therefore, the inventors of the present application and the like has substituted diameter 2x of processing mark 21 into the beam diameter of laser light LB in Mathematical formulas (1) and (2) to derive an optimum focal position.

[Effects and the Like]

As described above, laser processing device 10 according to the first embodiment includes laser head 1 that emits laser light LB and camera 3 that acquires a surface image of processing member 20 after being irradiated with the laser light. Laser processing device 10 further includes image processor 4 that performs image processing on an acquired surface image and calculates a diameter 2x of processing mark 21, and autofocus controller 5 that derives an optimum focal position of laser light LB based on diameter 2x of processing mark 21. In addition, laser processing device 10 includes driver 6 that moves laser head 1 in an emission direction of laser light LB to allow laser light LB to be condensed at an optimum focal position based on the derivation result of autofocus controller 5.

According to the present first exemplary embodiment, it is possible for a worker on site who operates laser processing device 10 to automatically correct a focal position of laser light LB without requiring a dedicated device or a maintenance worker having special skills. In addition, this makes it possible to reduce downtime of laser processing device 10 and suppress deterioration in processing productivity.

Image processor 4 identifies processing mark 21 and heat-affected zone 22 formed around processing mark 21 in the surface image of processing member 20, and calculates diameter 2x of processing mark 21.

In this way, it is possible to improve a measurement accuracy of diameter 2x of processing mark 21 that is data on which an optimum focal position is derived, and eventually to improve a derivation accuracy of an optimum focal position. Furthermore, by doing so, for example, as shown in PTL 2, it is not necessary to form a linear processing mark and determine an optimum focal position and the like based on the linear processing mark, and a correction work can be simplified.

A beam diameter of laser light LB on a surface of processing member 20 is defined as 2x, and a focal position of laser light LB with respect to a tip of laser head 1 is defined as z₀. A distance from the tip of laser head 1 to the surface of processing member 20 is defined as z, and a beam diameter of laser light LB at the beam waist is defined as 2w. A Rayleigh length of laser light LB is defined as z_{R}, and a beam divergence angle of laser light LB is defined as θ. When each parameter is defined in this way, focal position z₀ satisfies a relationship shown in Mathematical formula (2).

$$\begin{matrix}[ Mathematical formula 2 ] & \\ {z}_{0} = z {-}_{} {z}_{R} \sqrt{{( \frac{x}{w} )}^{2} - 1} = z - \frac{x}{tan θ} & ( 2 )\end{matrix}$$

Autofocus controller 5 derives distance z at which the difference from focal position z₀ is minimum as an optimum focal position. Note that, as described above, the theoretical minimum value of the difference between distance z and focal position z₀ is w/tan θ. However, there is a case in which distance z between laser processing device 10 and processing member 20 cannot be close to the minimum value. Also in such a case, autofocus controller 5 may derive distance z at which a difference from focal position z₀ becomes a predetermined value as an optimum focal position. The predetermined value in this case is a lower limit value that can be taken by distance z due to a structure of laser processing device 10 or a relationship with the shape of processing member 20.

By doing so, an optimum focal position can be accurately derived.

The method for automatically correcting a focal position of laser light LB emitted from laser head 1 according to the first embodiment includes the following steps.

The method for automatically correcting a focal position of laser light LB includes a first step (step S4 in FIG. 2) of spot-irradiating processing member 20 with laser light LB and a second step (step S5 in FIG. 2) of acquiring a surface image of processing member 20 irradiated with laser light LB. The method includes a third step (step S6 in FIG. 2) of measuring diameter 2x of processing mark 21 formed on a surface of processing member 20 based on a surface image of processing member 20 acquired in the second step, and a fourth step (step S9 in FIG. 2) of deriving an optimum focal position of laser light LB based on diameter 2x of processing mark 21. In addition, the method includes a fifth step (step S10 in FIG. 2) of moving laser head 1 in the Z direction that is an emission direction of laser light LB to allow the laser light LB to be condensed at an optimum focal position.

According to the present first exemplary embodiment, it is possible for a worker on site who operates laser processing device 10 to automatically correct a focal position of laser light LB without requiring a dedicated device or a maintenance worker having special skills. In addition, this makes it possible to reduce downtime of laser processing device 10 and suppress deterioration in processing productivity.

In the third step, processing mark 21 and heat-affected zone 22 formed around processing mark 21 in a surface image of processing member 20 are identified, and diameter 2x of processing mark 21 is calculated.

In this way, it is possible to improve a measurement accuracy of diameter 2x of processing mark 21 that is data on which an optimum focal position is derived, and eventually to improve a derivation accuracy of an optimum focal position.

The method for automatically correcting a focal position of laser light LB further includes, after the third step, a sixth step (step S3 in FIG. 2) of moving laser head 1 by a predetermined distance in the Z direction. In addition, the method further includes a seventh step (step S8 in FIG. 2) of calculating a difference between distance z from the tip of laser head 1 to the surface of processing member 20 and focal position z₀ of laser light LB, at each time after repeatedly executing the first step, the second step, the third step, and the sixth step a predetermined number of times (=N times). In the fourth step, an optimum focal position is derived based on a calculation result in the seventh step.

In this way, it is possible for a worker on site who operates laser processing device 10 to automatically correct a focal position of laser light LB without requiring a dedicated device or a maintenance worker having special skills.

In addition, as described above, focal position z₀ satisfies the relationship shown in Mathematical formula (2), and in the fourth step, distance z at which a difference to focal position z₀ is a predetermined value is derived as an optimum focal position.

By doing so, an optimum focal position can be accurately derived.

In the present description, laser head 1 is moved in the Z direction to allow laser light LB to be condensed at an optimum focal position, but the optical component inside laser head 1 may be moved by driver 6. For example, a focal position of laser light LB can be changed by, for example, moving a collimator lens in the Z direction.

Furthermore, the power of laser light LB applied to processing member 20 at the time of spot welding may be different from the power at the time of actual processing. If the power of laser light LB is too large, spatter may be scattered on a surface of processing mark 21 or around the surface of processing mark 21, and a measurement accuracy of diameter 2x of processing mark 21 is deteriorated in some cases. The power of laser light LB used at the time of automatic correction may be smaller than the power at the time of actual processing. For example, in an example illustrated in FIG. 6, the power of laser light LB is set to 0.3 kW. However, the power of laser light LB used at the time of automatic correction needs to be set to such an extent that processing mark 21 can be clearly recognized by camera 3.

In addition, processing member 20 used at the time of automatic correction may be different in shape and material from a member to be actually processed. It is sufficient that processing mark 21 can be reliably formed by irradiation with laser light LB. In addition, it is sufficient that processing mark 21 can be clearly recognized with respect to heat-affected zone 22 by camera 3.

### Second Exemplary Embodiment

[Configuration of Laser Processing Device]

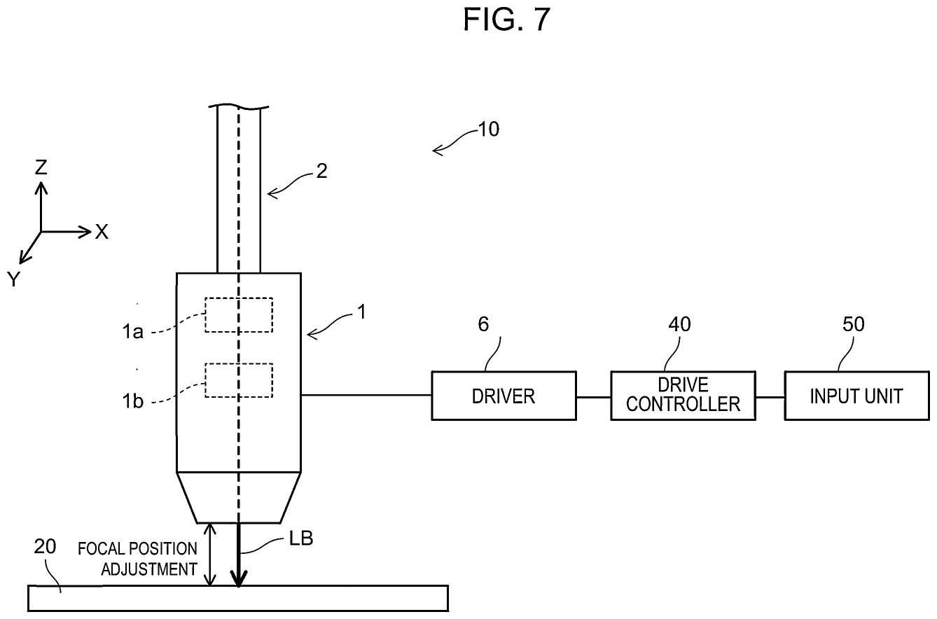

FIG. 7 is a schematic configuration diagram of a laser processing device according to the present second exemplary embodiment, and laser processing device 10 includes a laser head 1, a driver 6, a drive controller 40, and an input unit 50. Furthermore, laser processing device 10 includes an optical fiber 2.

Note that laser processing device 10 includes a laser oscillator generating laser light LB, a laser controller controlling the laser oscillator, and the like, but for convenience of description, components other than ones illustrated in FIG. 7 are not illustrated and detailed description is omitted.

Furthermore, in the following description, an optical axis direction of laser light LB emitted from laser head 1 (hereinafter may be simply referred to as an emission direction of laser light LB) may be referred to as a Z direction. Furthermore, two directions located in a plane intersecting with the Z direction that intersect with each other may be referred to as an X direction and a Y direction. In an example illustrated in FIG. 7, a surface of a processing member 20 having a flat shape corresponds to a plane including the X direction and the Y direction.

Laser head 1 receives laser light LB from optical fiber 2 and emits light toward processing member 20. The laser head 1 internally includes a plurality of optical components, for example, collimator lens 1a and condenser lens 1b. In addition, a protective glass (not illustrated) is provided to cover an opening (not illustrated) provided at the tip of laser head 1. However, not only they but also other optical components such as a reflection mirror may be disposed inside laser head 1.

When laser light LB enters laser head 1 from optical fiber 2, laser light LB is converted into a parallel light by a collimator lens 1a. Laser light LB is further condensed at a predetermined focal position by the condenser lens 1b.

Optical fiber 2 is an optical member that transmits laser light LB generated by a laser oscillator (not illustrated) to laser head 1.

Driver 6 moves laser head 1 in the Z direction that is an emission direction of laser light LB. Drive controller 40 controls an operation of driver 6. Input unit 50 is provided to input a parameter related to a movement amount of driver 6 to drive controller 40. For example, driver 6 extends in the Z direction and includes a ball screw (not illustrated) connected to laser head 1 and a stepping motor (not illustrated) connected to the ball screw. Drive controller 40 is a motor driver, and input unit 50 is a teaching pendant. For example, distance z and focal position z₀ that will be described later, or a difference between them is input from the teaching pendant to drive controller 40.

Note that driver 6 is not particularly limited to the structure described above. For example, driver 6 may be a manual type as long as a movement amount is visually recognizable by a worker on site. In that case, drive controller 40 can be omitted. In addition, input unit 50 can be omitted in an application of correcting a focal position of laser light LB.

[Method for Correcting Focal Position of Laser Light]

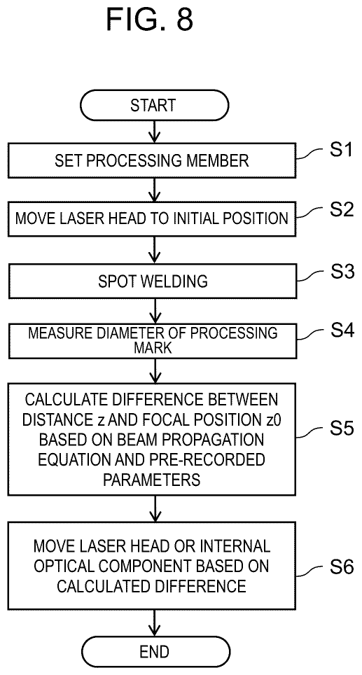

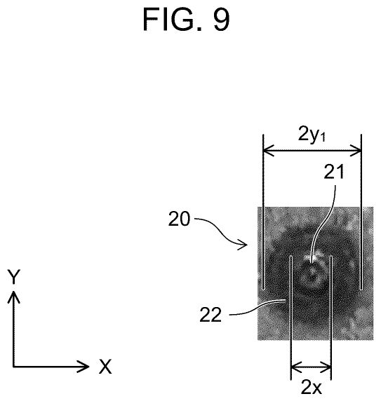

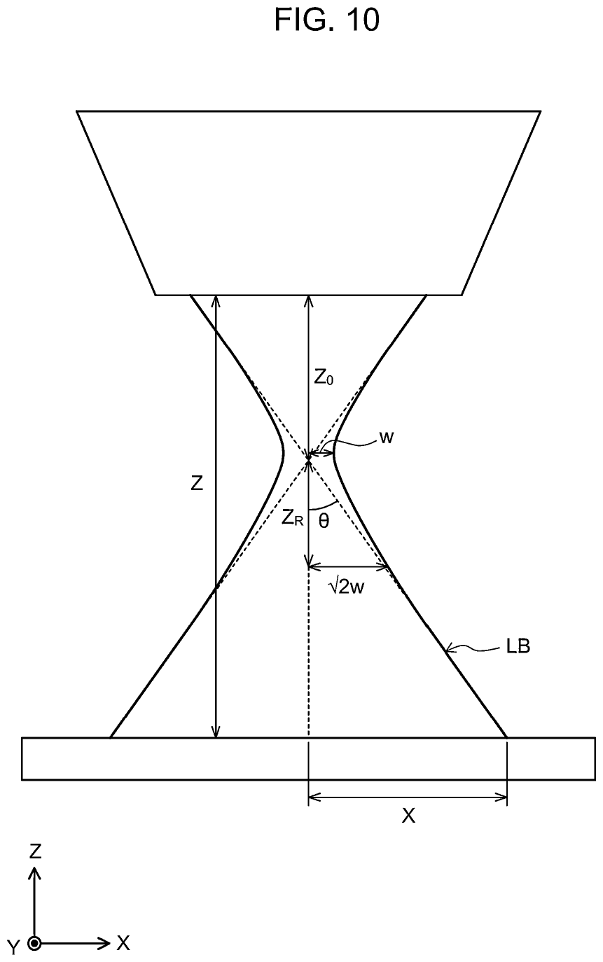

FIG. 8 illustrates a flowchart of a procedure of correcting a focal position of the laser light, FIG. 9 illustrates an example of a processing mark and a heat-affected zone formed on a surface of the processing member, and FIG. 10 schematically illustrates a relationship between the beam diameter of the laser light and the focal position.

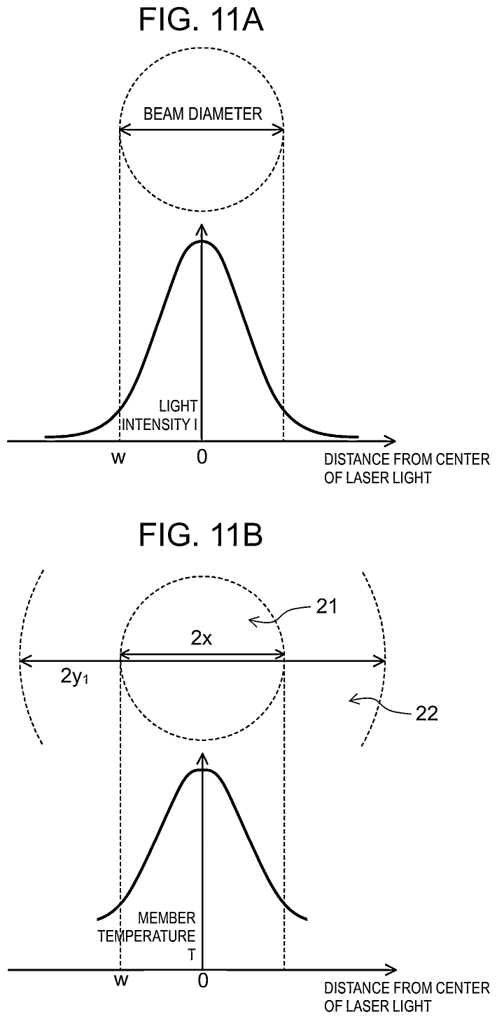

FIG. 11A schematically illustrates a relationship between a distance from the center of the laser light and a light intensity, and FIG. 11B schematically illustrates a relationship between a distance from the center of the laser light and a member temperature.

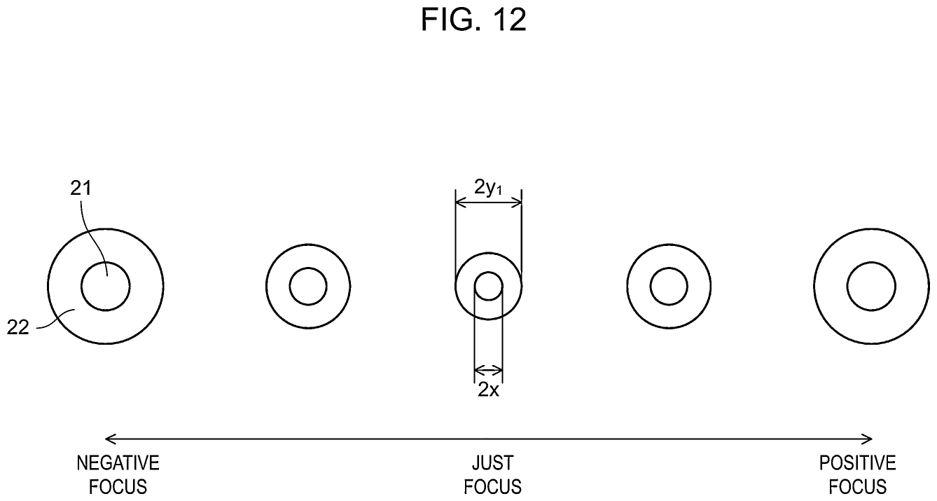

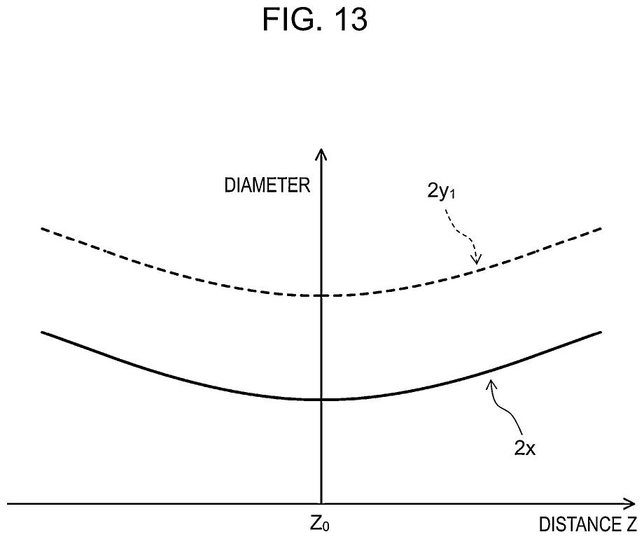

FIG. 12 schematically illustrates a state of a change in size of a processing mark and a heat-affected zone when a height of a laser head is changed. FIG. 13 is an example illustrating a relationship between a distance from the tip of the laser head to the processing member and diameters of the processing mark and the heat-affected zone.

In correcting a focal position of laser light LB, as illustrated in FIG. 8, first, processing member 20 is set at a predetermined position (step S1), and laser head 1 is moved to an initial position (step S2).

Processing member 20 is spot-welded by spot irradiation with laser light LB (step S3). Furthermore, diameter 2x of processing mark 21 formed by spot welding is measured (step S4).

Note that processing mark 21 is a mark obtained by cooling and solidifying a molten portion formed when a surface of processing member 20 is irradiated with laser light LB (see FIG. 9). In addition, in measuring diameter 2x of processing mark 21, it is necessary to identify heat-affected zone 22 and processing mark 21 formed around processing mark 21.

When processing mark 21 is formed, a temperature is greatly increased around processing mark 21 although processing mark 21 is not melted. Therefore, properties of processing member 20, for example, a structure or a composition changes in some cases. Alternatively, the surface unevenness of processing member 20 greatly changes in some cases. When processing mark 21 is formed in this manner, a portion where the property, surface unevenness, or the like formed around processing mark 21 are changed due to temperature rise is referred to as a heat-affected zone 22 (see FIG. 9) in the present description. They will be further described later.

Note that, in measuring diameter 2x of processing mark 21, the diameter of processing mark 21 after spot welding may be directly measured by a measuring instrument such as a caliper. Alternatively, processing mark 21 after spot welding may be imaged, and diameter 2x of processing mark 21 may be measured from the image.

Next, based on a known beam propagation equation and the following parameters, a difference between a distance z (hereinafter may be simply referred to as a distance z) from the tip of laser head 1 to the surface of processing member 20 and focal position z₀ (hereinafter may be simply referred to as focal position z₀) of laser light LB with respect to the tip of laser head 1 is calculated (step S5).

As illustrated in FIG. 10, a beam diameter of laser light LB emitted from laser head 1 is the smallest at the beam waist. When laser light LB further travels from this position, laser light LB spreads with a predetermined beam divergence angle, and the beam diameter increases.

A wavelength of laser light LB is defined as λ. A beam diameter of laser light LB on a surface of processing member 20 is defined as 2x, and a focal position of laser light LB with respect to a tip of laser head 1 is defined as z₀. The beam diameter of laser light LB at the beam waist is defined as 2w. A Rayleigh length of laser light LB is defined as z_{R}, and a beam divergence angle of laser light LB is defined as θ. When each parameter is defined in this way, a known beam propagation equation satisfies a relationship shown in Mathematical formula (1).

$$\begin{matrix}[ Mathematical formula 1 ] & \\ x = w \sqrt{1 + {( \frac{λ ( z - {z}_{0} )}{π {w}^{2}} )}^{2}} = w \sqrt{1 + {( \frac{z - {z}_{0}}{{z}_{R}} )}^{2}} = ( z - {z}_{0} ) tan θ & ( 1 )\end{matrix}$$

In addition, it can be seen that, when Mathematical formula (1) is transformed, focal position z₀ satisfies a relationship shown in Mathematical formula (2).

$$\begin{matrix}[ Mathematical formula 2 ] & \\ {z}_{0} = z - {z}_{R} \sqrt{{( \frac{x}{w} )}^{2} - 1} = z - \frac{x}{tan θ} & ( 2 )\end{matrix}$$

As described above, a beam diameter of laser light LB is the smallest at the beam waist. Therefore, if a surface of processing member 20 is disposed at this position, processing member 20 can be subjected to laser processing with the beam being most focused. As is clear from FIG. 10 and Mathematical formula (2), a difference between distance z and focal position z₀ is obtained, and the tip of laser head 1 is moved to distance z at which the difference is minimized. With this adjustment, laser light LB emitted from laser head 1 is condensed at the optimum focal position. Note that, as is clear from FIG. 10, a theoretical minimum value of the difference between distance z and focal position z₀ is w/tan θ.

Each parameter described above is acquired in advance. For example, the wavelength λ is known in advance. Distance z (or Focal position z₀), Rayleigh length z_{R}, beam diameter 2w, and beam divergence angle θ are experimentally obtained in advance. These values only need to be stored in a format that can be visually recognized by a worker on site at the time of correcting a focal position and can be input to the input unit as necessary. For example, these values may be stored in a personal computer used by a worker on site, or may be stored as a paper file.

Laser head 1 is moved in the Z direction to minimize the difference (step S6), and the correction of the focal position is completed.

Here, as described above, when a beam diameter of laser light LB is directly measured, a dedicated device such as a focus monitor is required. In addition, a maintenance worker who can operate the dedicated device is required.

Therefore, inventors of the present application have focused on processing mark 21 formed by spot welding instead of directly measuring the beam diameter. A size of processing mark 21 corresponds to a beam diameter of laser light LB on a surface of processing member 20.

As illustrated in FIG. 11 A, a light intensity of laser light LB has a Gaussian distribution, and satisfies a relationship represented by Mathematical formula (3).

$$\begin{matrix}[ Mathematical formula 3 ] & \\ I = {I}_{0} exp ( - \frac{{r}^{2}}{{w}^{2}} ) & ( 3 )\end{matrix}$$

where,
r: distance from center of laser light LB
I₀: light intensity in a case of r=0

In laser light LB having such a light intensity distribution, doubling of the distance r in a case where the light intensity I/I₀ is 1/e² is often selected as the above-described 2x.

On the other hand, as illustrated in FIG. 11B, a member temperature T, which is a temperature of processing member 20, also has a distribution close to the Gaussian distribution with respect to the distance r from the center of laser light LB. Actually, the member temperature T satisfies the relationship represented by Mathematical formula (4).

$$\begin{matrix}[ Mathematical formula 4 ] & \\ T ( R , Z , W ) = \frac{{I}_{0} {w}^{2}}{α K} \times {\int }_{0}^{∞} {J}_{0} ( λ R ) F ( λ ) \frac{W exp ( - λ Z ) - λexp ( - WZ )}{{W}^{2} - {λ}^{2}} d λ & ( 4 )\end{matrix}$$

where,
T(R, Z, W): member temperature T as a function of R, Z, W
α: attenuation rate of laser light
K: thermal conductivity
F(R): Bessel transform of f(R)=exp(−R²)
R: r/w
Z: z/w
W: αw

According to the fact that the member temperature T satisfies a relationship shown in Mathematical formula (4), shapes of processing mark 21 and heat-affected zone 22 are each substantially circular in plan view as illustrated in FIGS. 10 and 11B.

As illustrated in FIG. 12, both diameter 2x of processing mark 21 and diameter 2y₁ of heat-affected zone 22 change depending on a focus state of laser light LB. In a case where a height of laser head 1 is not appropriately set, in an example illustrated in FIG. 12, when laser light LB swings to a positive focus, diameter 2x of processing mark 21 and diameter 2y₁ of heat-affected zone 22 both increase. Similarly, when laser light LB swings to a negative focus, diameter 2x of processing mark 21 and diameter 2y₁ of heat-affected zone 22 both increase. When laser light LB is in a just focus state, that is, laser light LB is at an optimum focal position, both diameter 2x of processing mark 21 and diameter 2y₁ of heat-affected zone 22 are minimum.

FIG. 13 illustrates, as an example, changes in diameter 2x of processing mark 21 and diameter 2y₁ of heat-affected zone 22 with respect to distance z. In an example illustrated in FIG. 13, diameter 2x of processing mark 21 and diameter 2y₁ of heat-affected zone 22 similarly tend to change with respect to distance z, and both have a minimum value when distance z is equal to z₀.

In this example, it seems that a difference between distance z and focal position z₀ can be calculated by using either diameter 2x of processing mark 21 or diameter 2y₁ of heat-affected zone 22. However, diameter 2y₁ of heat-affected zone 22 is affected more greatly than diameter 2x of processing mark 21 by variations in a material of processing member 20. In addition, since the contrast of a peripheral edge of heat-affected zone 22 is less clear than the contrast of a peripheral edge of processing mark 21, a measurement accuracy of diameter 2y₁ may decrease.

Therefore, the inventors of the present application and the like have substituted diameter 2x of processing mark 21 into the beam diameter of laser light LB in Mathematical formulas (1) and (2) to calculate a difference between distance z and focal position z₀. In this manner, by setting the diameter of processing mark 21 to 2x in Mathematical formulas (1) and (2), the focal position of laser light LB can be corrected by the above-described procedure.

[Effects and the Like]

As described above, the method for correcting a focal position of laser light LB emitted from laser head 1 according to the second exemplary embodiment includes the following steps.

The method for correcting a focal position of laser light LB includes a first step (step S3 in FIG. 8) of spot-irradiating processing member 20 with laser light LB and a second step (step S4 in FIG. 8) of measuring a diameter 2x of processing mark 21 formed on a surface of processing member 20. The method includes a third step (step S5 in FIG. 8) of calculating a difference between distance z from a surface of processing member 20 to the tip of laser head 1 and focal position z₀ of laser light LB obtained in advance based on diameter 2x of processing mark 21, and a fourth step (step S6 in FIG. 8) of moving laser head 1 in the Z direction that is the emission direction of laser light LB to minimize the difference.

According to the present second exemplary embodiment, it is possible for a worker on site who operates laser processing device 10 to correct a focal position of laser light LB without requiring a dedicated device or a maintenance worker having special skills. In addition, this makes it possible to reduce downtime of laser processing device 10 and suppress deterioration in processing productivity. Furthermore, since a focal position can be easily corrected, laser processing is not performed in a state where the focal position is greatly shifted. This makes it possible to perform laser processing with stable processing quality.

In the second step, processing mark 21 and heat-affected zone 22 formed around processing mark 21 are identified, and then diameter 2x of processing mark 21 is calculated.

In this way, it is possible to improve a measurement accuracy of diameter 2x of processing mark 21 that is data on which a difference between distance z and focal position z₀ is calculated, and eventually to improve a correction accuracy of the focal position.

In addition, a diameter of processing mark 21 on a surface of processing member 20 is defined as 2x, and a focal position of laser light LB with respect to the tip of laser head 1 is defined as z₀. A distance from the tip of laser head 1 to the surface of processing member 20 is defined as z, and a beam diameter of laser light LB at the beam waist is defined as 2w. A Rayleigh length of laser light LB is defined as z_{R}, and a beam divergence angle of laser light LB is defined as θ. When each parameter is defined in this way, in the third step, a difference between distance z and focal position z₀ is calculated based on Mathematical formula (2).

By doing so, a focal position can be accurately corrected.

Note that, as described above, the theoretical minimum value of the difference between distance z and focal position z₀ is w/tan θ. However, there is a case in which distance z between laser processing device 10 and processing member 20 cannot be close to the minimum value. Also in such a case, the focal position of laser light LB may be corrected in order to make a difference between distance z and focal position z₀ become a predetermined value. The predetermined value in this case is a lower limit value that can be taken by the difference between distance z and focal position z₀ due to a structure of laser processing device 10 or a relationship with the shape of processing member 20.

Note that, in the present description, laser head 1 is moved in the Z direction but the optical component inside laser head 1 may be moved by driver 6. For example, a focal position of laser light LB can be changed by, for example, moving a collimator lens 1a in the Z direction.

Furthermore, the power of laser light LB applied to processing member 20 at the time of spot welding may be different from the power at the time of actual processing. If the power of laser light LB is too large, spatter may be scattered on a surface of processing mark 21 or around the surface of processing mark 21, and a measurement accuracy of diameter 2x of processing mark 21 is deteriorated in some cases. The power of laser light LB used at the time of correction may be smaller than the power at the time of actual processing. However, the power of laser light LB used at the time of correction needs to be set to such an extent that processing mark 21 can be clearly recognized.

In addition, processing member 20 used at the time of correction may be different in shape and material from a member to be actually processed. It is sufficient that processing mark 21 can be reliably formed by irradiation with laser light LB. In addition, it is sufficient that processing mark 21 can be clearly recognized with respect to heat-affected zone 22.

### INDUSTRIAL APPLICABILITY

The laser processing device of the present disclosure is useful because it can correct the focal position of the laser light without requiring dedicated a device or a maintenance worker.

### REFERENCE MARKS IN THE DRAWINGS

1 laser head
1a collimator lens
1b condenser lens
2 optical fiber
3 camera
4 image processor
5 autofocus controller
6 driver
10 laser processing device
20 processing member
21 processing mark
22 heat-affected zone
40 drive controller
50 input unit

1. A laser processing device comprising:
a laser head that emits laser light;
a camera that acquires a surface image of a processing member that has been irradiated with the laser light;
an image processor that calculates a diameter of a processing mark by performing image processing on the acquired surface image;
an autofocus controller that derives an optimum focal position of the laser light based on the diameter of the processing mark; and
a driver that moves the laser head or an optical component inside the laser head in an emission direction of the laser light based on a derivation result of the autofocus controller to allow the laser light to be condensed at the optimum focal position.

2. The laser processing device according to claim 1,
wherein the image processor identifies the processing mark in the surface image of the processing member and a heat-affected zone formed around the processing mark, and calculates the diameter of the processing mark.

3. The laser processing device according to claim 2,
wherein when the diameter of the processing mark is 2x, a focal position of the laser light with respect to a tip of the laser head is z₀, a distance from the tip of the laser head to a surface of the processing member is z, a beam diameter of the laser light at a beam waist is 2w, a Rayleigh length of the laser light is z_{R}, and a beam divergence angle of the laser light is θ, the focal position z₀ satisfies a relationship shown in Mathematical formula (2):
$$\begin{matrix}[ Mathematical formula 2 ] & \\ {z}_{0} = z {-}_{} {z}_{R} \sqrt{{( \frac{x}{w} )}^{2} - 1} = z - \frac{x}{tan θ} & ( 2 )\end{matrix}$$
and
the autofocus controller derives the distance z at which a difference from the focal position z₀ becomes a predetermined value as the optimum focal position.

4. A method for automatically correcting a focal position of laser light, the laser light being emitted from a laser head, the method comprising:
a first step of spot-irradiating a processing member with the laser light;
a second step of acquiring a surface image of the processing member after irradiation with the laser light;
a third step of measuring a diameter of a processing mark formed on a surface of the processing member based on the surface image of the processing member acquired in the second step;
a fourth step of deriving an optimum focal position of the laser light based on the diameter of the processing mark; and
a fifth step of moving the laser head or an optical component inside the laser head in an emission direction of the laser light to allow the laser light to be condensed at the optimum focal position.

5. The method according to claim 4,
wherein in the third step, the processing mark in the surface image of the processing member and a heat-affected zone formed around the processing mark are identified, and the diameter of the processing mark is calculated.

6. The method according to claim 5, further comprising:
a sixth step of moving the laser head by a predetermined distance in the emission direction of the laser light after the second step; and
a seventh step of repeatedly executing the first step, the second step, the third step, and the sixth step a predetermined number of times, and then calculating a difference between a distance from a tip of the laser head to the surface of the processing member and the focal position of the laser light in each step,
wherein in the fourth step, the optimum focal position is derived based on the calculation result in the seventh step.

7. The method according to claim 6,
wherein when the diameter of the processing mark is 2x, the focal position of the laser light with respect to the tip of the laser head is z₀, the distance from the tip of the laser head to the surface of the processing member is z, a beam diameter of the laser light at a beam waist is 2w, a Rayleigh length of the laser light is z_{R}, and a beam divergence angle of the laser light is θ, the focal position z₀ satisfies a relationship shown in Mathematical formula (2):
$$\begin{matrix}[ Mathematical formula 2 ] & \\ {z}_{0} = z - {z}_{R} \sqrt{{( \frac{x}{w} )}^{2} - 1} = z - \frac{x}{tan θ} & ( 2 )\end{matrix}$$
and
the fourth step derives the distance z at which a difference from the focal position z₀ becomes a predetermined value as the optimum focal position.

8. A method for correcting a focal position of laser light, the laser light being emitted from a laser head, the method comprising:
a first step of spot-irradiating a processing member with the laser light;
a second step of measuring a diameter of a processing mark formed on a surface of the processing member;
a third step of calculating a difference between a distance from the surface of the processing member to a tip of the laser head and a focal position of the laser light obtained in advance based on the diameter of the processing mark; and
a fourth step of moving the laser head or an optical component inside the laser head in an emission direction of the laser light to make the difference become a predetermined value.

9. The method according to claim 8,
wherein in the second step, the processing mark and a heat-affected zone formed around the processing mark are identified, and then the diameter of the processing mark is calculated.

10. The method according to claim 9,
wherein when the diameter of the processing mark is 2x, the focal position of the laser light with respect to the tip of the laser head is z₀, the distance from the tip of the laser head to the surface of the processing member is z, a beam diameter of the laser light at a beam waist is 2w, a Rayleigh length of the laser light is z_{R}, and a beam divergence angle of the laser light is θ, a difference between the distance z and the focal position z₀ is calculated, in the third step, based on Mathematical formula (2).
$$\begin{matrix}[ Mathematical formula 2 ] & \\ {z}_{0} = z {-}_{} {z}_{R} \sqrt{{( \frac{x}{w} )}^{2} - 1} = z - \frac{x}{tan θ} & ( 2 )\end{matrix}$$
